(19) United States
(12) Patent Application Publication
(10) Pub. No.: US 2020/0171773 A1
(43) Pub. Date: Jun. 4, 2020

(54) PRESS SYSTEM AND METHOD OF CONTROLLING PRESS SYSTEM

(71) Applicant: KOMATSU INDUSTRIES CORPORATION, Kanazawa-shi, Ishikawa (JP)

(72) Inventors: Hitoshi SAKURAI, Kanazawa-shi, Ishikawa (JP); Koyo YAMAZAKI, Kanazawa-shi, Ishikawa (JP); Atsuo OKETANI, Kanazawa-shi, Ishikawa (JP); Toshihiro MINAMI, Kanazawa-shi, Ishikawa (JP)

(73) Assignee: KOMATSU INDUSTRIES CORPORATION, Kanazawa-shi, Ishikawa (JP)

(21) Appl. No.: 16/615,564

(22) PCT Filed: May 28, 2018
(86) PCT No.: PCT/JP2018/020346

§ 371 Date: Nov. 21, 2019

(30) Foreign Application Priority Data
Sep. 26, 2017 (JP) 2017-184544

(51) Int. Cl. B30B 15/14

(52) U.S. Cl. CPC B30B 15/14

(57) ABSTRACT

A controller controls a slide to stop when the slide moves upward and downward as a result of operation of a two-hand push button panel to reach a target position (for example, a feed-allowable height, a touch position, a work end position, and a jump prevention height) even though an operation signal from the two-hand push button panel is being input to the controller.

### TECHNICAL FIELD

The present invention relates to a press system and a method of controlling a press system.

### BACKGROUND ART

A servo press includes an electric servo motor for having a slide move upward and downward and a servo amplifier configured to control a rotation speed of the electric servo motor. When the servo press performs press working, a prescribed motion curve of a slide is set in advance, and upward and downward movement of the slide is controlled by driving the electric servo motor in accordance with the motion curve.

An inching mode represents one of operation modes of the servo press as above. The inching mode is described, for example, in Japanese Patent Laying-Open No. 11-58092 (PTL 1). The inching mode refers to an operation mode in which a slide is moved in a prescribed motion while an operation button is kept pressed by a two-hand operation.

### CITATION LIST

### Patent Literature

PTL 1: Japanese Patent Laying-Open No. 11-58092

### SUMMARY OF INVENTION

### Technical Problem

Stop of a slide accurately at an aimed angle (a slide position) may be desired for checking a state of contact between a die and a workpiece off-line outside the press. In this case, initially, an operation mode is set to the inching mode and the slide is moved to a certain angle. Thereafter, the slide is stopped at the aimed angle by finely adjusting the angle by using a manual pulser.

With this method, however, time for moving the slide to an aimed angle is greatly different depending on difference in experiences of a press operator. Therefore, when an unskilled person operates the slide, a long time is required for moving the slide to an accurate position or the slide cannot be stopped at an accurate position.

An object of the present invention is to provide a press system with which even an unskilled person with experience can accurately stop a slide at a prescribed position in a short period of time when the slide is moved in a prescribed slide motion only while an operation portion is outputting an operation signal as in an inching mode and a method of controlling the press system.

### Solution to Problem

A press system in the present disclosure includes a slide, a storage, an operation portion, and a controller. The slide is included in a press apparatus and moves upward and downward. The storage stores a target position in upward and downward movement of the slide. The operation portion outputs an operation signal for having the slide move upward and downward. The controller controls the slide to move upward and downward in accordance with a slide motion set in advance only while the operation portion is outputting the operation signal and to stop when the slide reaches the target position by having the slide move upward and downward while the operation signal from the operation portion is being input.

A method of controlling a press system in the present disclosure includes steps below.

Whether or not a step operation mode has been selected is determined. Whether or not an operation signal is being output from an operation portion is determined. While the operation signal from the operation portion is being input to a controller, a slide moves upward and downward in accordance with a slide motion set in advance. Whether or not the slide has reached a target position by upward and downward movement is determined. When it is determined that the slide has reached the target position, with the step operation mode having been selected, the slide is forcibly stopped while the operation signal from the operation portion is being input to the controller.

### Advantageous Effects of Invention

According to the present disclosure, when it is determined that the slide has reached the target position, the slide is stopped. Therefore, when the slide is moved in a prescribed slide motion only while the operation portion is outputting the operation signal, even an unskilled person with experience can accurately stop the slide at a prescribed position in a short period of time.

### BRIEF DESCRIPTION OF DRAWINGS

FIG. 1 is a diagram illustrating a construction of a press system based on an embodiment.

FIG. 2 is a perspective view of a press apparatus based on the embodiment.

FIG. 3 is a lateral cross-sectional view showing a main portion of the press apparatus.

FIG. 4 is a plan view of a partial cross-section showing another main portion of the press apparatus.

FIG. 5 is a diagram illustrating overview of a drive system of the press system based on the embodiment.

FIG. 6 is a functional block diagram of the press system based on the embodiment.

FIG. 7 is a schematic diagram showing arrangement of a die and a workpiece when a slide is located at a feed-allowable height.

FIG. 8 is a schematic diagram showing arrangement of the die and the workpiece when the slide is located at a touch position.

FIG. 9 is a schematic diagram showing arrangement of the die and the workpiece when the slide is located at a work end position.

FIG. 10 is a schematic diagram showing arrangement of the die and the workpiece when the slide is located at a jump prevention height.

FIG. 11 is a diagram illustrating an angle of rotation of a main shaft corresponding to each position representing a slide position parameter.

FIG. 12 is a diagram showing a press motion and a feeder motion generated by the press system based on the embodiment.

FIG. 13 is a flowchart showing a method of controlling a press system based on the embodiment.

### DESCRIPTION OF EMBODIMENTS

The present embodiment will be described in detail with reference to the drawings. The same or corresponding elements in the drawings have the same reference characters allotted and description thereof will not be repeated.

The present example relates to a press apparatus and describes a forward feed press apparatus by way of example.

<Overall Construction>

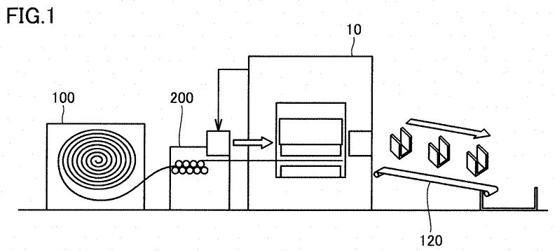

FIG. 1 is a diagram illustrating a construction of a press system based on an embodiment. As shown in FIG. 1, the press system includes an uncoiler 100, a leveler feeder (a transportation portion) 200, a press apparatus (a press portion) 10, and a conveyor 120.

A coil material (a plate in a form of a band) is wound around uncoiler 100. In the present embodiment, press working of the coil material as a workpiece (material) will be described. The coil material unwound from uncoiler 100 is transported to press apparatus 10 by leveler feeder 200.

Leveler feeder 200 adjusts a position of a feed height of the coil material transported from uncoiler 100 to press apparatus 10 and transports the coil material to press apparatus 10 under an operation condition (a feeder motion) in a set direction of transportation.

Press apparatus 10 press works the coil material transported from leveler feeder 200.

Conveyor 120 transports the workpiece formed by press working by press apparatus 10. Conveyor 120 can transport the formed workpiece, for example, to a next press apparatus.

Components in the press system are in synchronization with one another, and a series of processes is sequentially and successively performed. The coil material is transported from uncoiler 100 via leveler feeder 200 to press apparatus 10. Then, press apparatus 10 performs press working, and the worked workpiece is transported by conveyor 120. A series of processes above is repeated.

The above construction of the press system is by way of example and limitation thereto is not particularly intended.

Leveler feeder 200 is operated in accordance with an instruction from press apparatus 10. In this connection, a controller configured to control leveler feeder 200 is provided in press apparatus 10.

Though the present example describes a construction in which the controller configured to control leveler feeder 200 is provided in press apparatus 10, limitation thereto is not intended, and for example, a controller configured to control press apparatus 10 may be provided on a side of leveler feeder 200. A controller configured to control press apparatus 10 and leveler feeder 200 may be arranged at a position different from press apparatus 10 and leveler feeder 200 to remotely control press apparatus 10 and leveler feeder 200, The embodiment describes an example in which a single controller controls both of leveler feeder 200 and press apparatus 10.

<Press Apparatus>

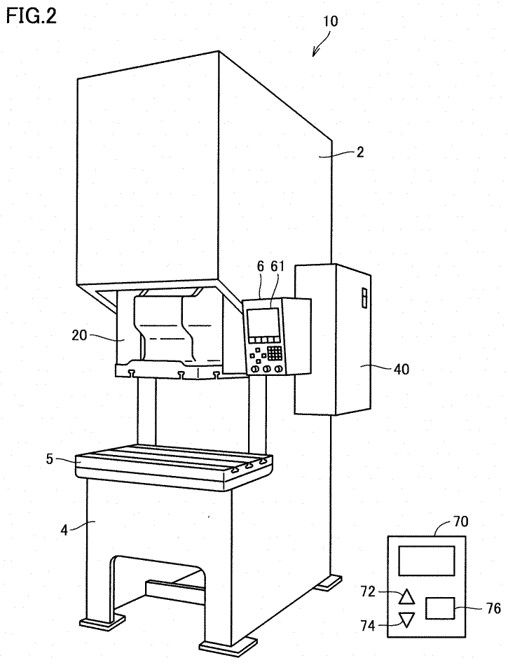

FIG. 2 is a perspective view of press apparatus 10 based on the embodiment.

FIG. 2 shows a forward feed press apparatus without a plunger by way of example.

Press apparatus 10 includes a main body frame 2, a slide 20, a bed 4, a bolster 5, a control panel 6, and a controller 40.

Slide 20 is supported in a substantially central portion of main body frame 2 of press apparatus 10 as being vertically movable. Bolster 5 attached onto bed 4 is arranged under slide 20. Control panel 6 is provided in front of main body frame 2. Controller 40 is provided laterally to main body frame 2. Control panel 6 is connected to controller 40.

An upper die of dice for working a workpiece is removably attached to a lower surface of slide 20. A lower die of the dice for working a workpiece is removably attached to an upper surface of bolster 5. Press working is performed by placing a prescribed workpiece corresponding to the dice on the lower die and lowering the upper die together with slide 20.

A remote controller (remote control unit) 70 to allow external remote control of press apparatus 10 by establishing communication with press apparatus 10 is provided. An operator (a person responsible for operation) can perform various setting operations by operating remote controller 70. Remote controller 70 can communicate with controller 40 to operate press apparatus 10 in accordance with an instruction therefrom.

The present example shows that remote controller 70 is provided with an up button 72 and a down button 74 for vertically moving slide 20 and an enter button 76.

Control panel 6 is provided to input various types of data necessary for controlling press apparatus 10. Control panel 6 includes a switch and a numeric keypad for inputting data and a display 61 configured to show a setting screen and data output from press apparatus 10.

Such a programmable display that a transparent touch switch panel is attached to a front surface of a graphic display such as a liquid crystal display or a plasma display is adopted as display 61.

Control panel 6 may include a data input device which receives input of data from an external storage medium such as an integrated circuit (IC) card where data set in advance is stored or a communication device which transmits and receives data wirelessly or through a communication line.

Though the present example describes a construction in which both of control panel 6 and remote controller 70 are provided for press apparatus 10, the construction of press apparatus 10 is by way of example and limitation thereto is not intended. For example, only one of control panel 6 and remote controller 70 may be provided for press apparatus 10.

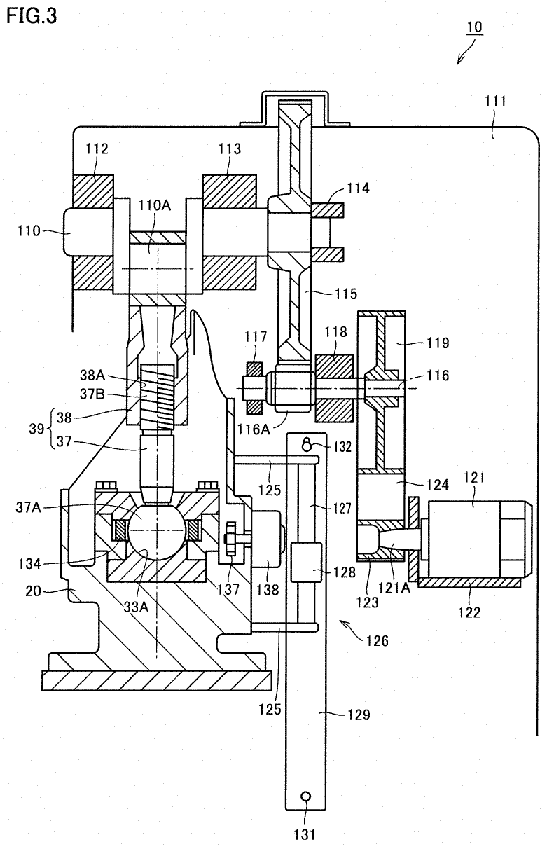

FIG. 3 is a lateral cross-sectional view showing a main portion of press apparatus 10. As shown in FIG. 3, press apparatus 10 is implemented by a servo press.

Press apparatus 10 includes a servo motor 121, a spherical hole 33A, a screw shaft 37, a spherical portion 37A, a thread portion 37B, and a connecting rod main body 38. Press apparatus 10 further includes a female thread portion 38A, a connecting rod 39, a main shaft 110, an eccentric portion 110A, a side frame 111, bearing portions 112 to 114, a main gear 115, a power transmission shaft 116, a transmission gear 116A, bearing portions 117 and 118, and a pulley 119.

In press apparatus 10, servo motor 121 drives slide 20. In spherical hole 33A provided in an upper portion of slide 20, spherical portion 37A provided at a lower end of screw shaft 37 for adjusting a die height is rotatably inserted so as not to come off.

Spherical hole 33A and spherical portion 37A make up a spherical joint. Thread portion 37B of screw shaft 37 is exposed upward through slide 20, and screwed to female thread portion 38A of connecting rod main body 38 provided above screw shaft 37. Screw shaft 37 and connecting rod main body 38 make up extendable connecting rod 39.

The die height refers to a distance from a lower surface of slide 20 at the time when slide 20 is arranged at a bottom dead center to an upper surface of bolster 5.

An upper portion of connecting rod 39 is rotatably coupled to eccentric portion 110A like a crank provided in main shaft 110. Main shaft 110 is movably supported by bearing portions 112, 113, and 114 located at three front and rear locations between a pair of left and right thick side frames 111 which form main body frame 2. Main gear 115 is attached to a rear portion of main shaft 110.

Main gear 115 is meshed with transmission gear 116A of power transmission shaft 116 provided below. Power transmission shaft 116 is movably supported by bearing portions 117 and 118 located at two front and rear locations between side frames 111. Power transmission shaft 116 has a rear end attached to driven pulley 119. Pulley 119 is driven by servo motor 121 arranged below.

Press apparatus 10 further includes a bracket 122, an output shaft 121A, a pulley 123, a belt 124, a bracket 125, a position detector 126, a rod 127, a position sensor 128, an auxiliary frame 129, and bolts 131 and 132.

Servo motor 121 is supported between side frames 111 with bracket 122 substantially in an L shape being interposed. Servo motor 121 has output shaft 121A projecting along a front-rear direction of press apparatus 10, and motive power is transmitted by belt 124 wound around driving pulley 123 and driven pulley 119 provided on output shaft 121A.

A pair of brackets 125 projecting rearward between side frames 111 from two upper and lower locations is attached on a rear surface side of slide 20. Rod 127 which implements position detector 126 such as a linear scale is attached between upper and lower brackets 125. Rod 127 is provided with a scale for detecting a vertical position of slide 20 and vertically movably fitted into position sensor 128 similarly implementing position detector 126. Position sensor 128 is fixed to auxiliary frame 129 provided in one side frame 111.

Auxiliary frame 129 is formed in a vertically elongated manner. The auxiliary frame has a lower portion attached to side frame 111 by bolt 131 and an upper portion vertically slidably supported by bolt 132 inserted in a vertically elongated hole. Auxiliary frame 129 has thus only any one side (a lower side in the present embodiment) of upper and lower sides fixed to side frame 111 and has the other side vertically movably supported. Therefore, auxiliary frame 129 is not affected by contraction and extension caused by variation in temperature of side frame 111. Position sensor 128 can thus accurately detect a slide position and a die height position without being affected by such contraction and extension of side frame 111.

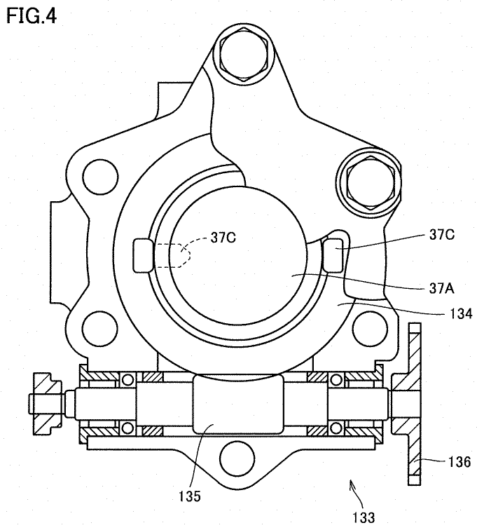

A slide position of slide 20 and a die height are adjusted by a slide position adjustment mechanism 133 (FIG. 4) provided in slide 20. FIG. 4 is a plan view of a partial cross-section showing another main portion of press apparatus 10.

As shown in FIG. 4, slide position adjustment mechanism 133 is constituted of a worm wheel 134 attached to an outer circumference of spherical portion 37A with a pin 37C being interposed, a worm gear 135 meshed with worm wheel 134, an input gear 136 attached to an end of worm gear 135, and an induction motor 138 including an output gear 137 (FIG. 3) meshed with input gear 136. Induction motor 138 is in a flat shape shorter in axial length and constructed to be compact. Screw shaft 37 can be turned by a rotary operation of induction motor 138 with worm wheel 134 being interposed. A length of screwing between thread portion 37B of screw shaft 37 and female thread portion 38A of connecting rod main body 38 is thus varied to adjust the slide position of slide 20 and the die height.

<Configuration of Drive System of Press System>

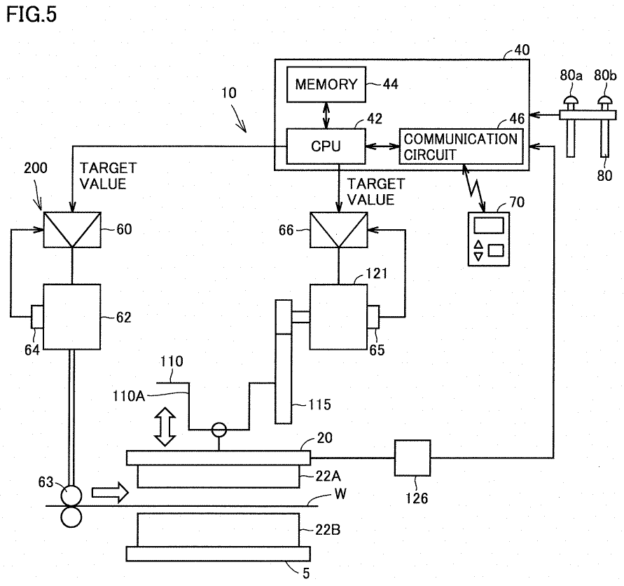

FIG. 5 is a diagram illustrating overview of a drive system of the press system based on the embodiment.

As shown in FIG. 5, leveler feeder 200 includes a transportation roller 63, a servo motor 62, an encoder 64, and a servo amplifier 60.

Press apparatus 10 includes controller 40, a servo amplifier 66, servo motor 121, an encoder 65, main gear 115, main shaft 110, eccentric portion 110A, slide 20, an upper die 22A, a lower die 22B, and bolster 5.

Controller 40 mainly includes a central processing unit (CPU) (control device) 42, a memory (storage) 44, and a communication circuit 46.

Communication circuit 46 is provided to be able to communicate with remote controller 70.

CPU 42 outputs a target value to servo amplifier 60. Servo amplifier 60 gives a speed instruction to servo motor 62 based on the target value. Transportation roller 63 performs an operation to transport a workpiece W as servo motor 62 is driven.

Encoder 64 outputs a feedback signal based on the number of rotations of servo motor 62 in accordance with the speed instruction to servo amplifier 60.

Servo amplifier 60 adjusts the number of rotations of servo motor 62 to a value in accordance with the target value by controlling supply of electric power to servo motor 62 based on the feedback signal from encoder 64.

Through the processing, CPU 42 controls a speed of transportation in the operation to transport workpiece W.

Similarly, CPU 42 outputs a target value to servo amplifier 66. Servo amplifier 66 gives a speed instruction to servo motor 121 based on the target value. Main gear 115 drives main shaft 110 as servo motor 121 is driven. As main shaft 110 is driven, eccentric portion 110A is rotated. Eccentric portion 110A is coupled to slide 20, and slide 20 to which upper die 22A is attached moves upward and downward in accordance with a rotary operation of eccentric portion 110A. As slide 20 is lowered to a position of the bottom dead center under an operation condition (press motion or slide motion) in the set upward and downward direction, press working of workpiece W transported to a position between upper die 22A and lower die 22B is performed.

Upper die 22A is a movable die which is reciprocatively vertically moved integrally with slide 20 with upward and downward movement of slide 20. Lower die 22B is a fixed die placed and fixed onto bolster 5.

Servo motor 121 follows a speed instruction to servo amplifier 66. Encoder 65 outputs a feedback signal in accordance with the number of rotations of servo motor 121.

Servo amplifier 66 adjusts the number of rotations of servo motor 121 to a value in accordance with the target value by controlling supply of electric power to servo motor 121 based on the feedback signal from encoder 65.

Through the processing, CPU 42 controls a speed of slide 20 in the upward and downward movement.

CPU 42 based on the embodiment performs processing for synchronizing a transportation operation by leveler feeder 200 (which is also simply referred to as a feeder) with upward and downward movement of slide 20 of press apparatus 10 based on control data stored in memory 44.

Specifically, memory 44 stores control data in which upward and downward movement of slide 20 is associated with a workpiece transportation operation by leveler feeder 200.

CPU 42 based on the embodiment controls a stop position of slide 20 in an inching mode and a step operation mode based on target position data of slide 20 in the inching mode and the step operation mode stored in memory 44. Specifically, the stop position of slide 20 in the inching mode and the step operation mode is controlled based on an operation signal from a two-hand push button panel 80 (operation portion), current position information of slide 20 detected by position detector 126, and the target position data.

Controller 40 receives input of an operation signal from two-hand push button panel 80 (operation portion). Two-hand push button panel 80 serves as an operation portion operated in the inching mode and the step operation mode and includes operation buttons 80a and 80b operated by both of left and right hands. In the inching mode and the step operation mode, while both of operation buttons 80a and 80b of two-hand push button panel 80 are kept pressed, slide 20 is moved in a prescribed slide motion (a motion set speed).

Controller 40 receives current position information of slide 20 detected by position detector 126.

<Functional Block of Press System>

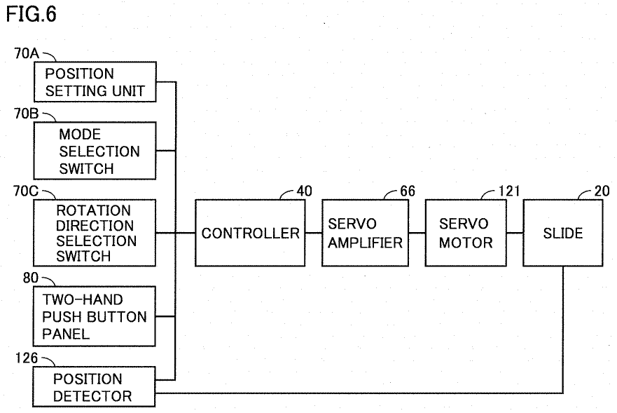

FIG. 6 is a functional block diagram of the press system based on the embodiment. As shown in FIG. 6, other than two-hand push button panel 80 and position detector 126, a position setting unit 70A, a mode selection switch 70B, and a rotation direction selection switch 70C are connected to controller 40.

Position setting unit 70A is a unit for an operator to set a target position in upward and downward movement of slide 20. The target position refers to a position, for example, set on a motion curve in upward and downward movement of slide 20.

The set position is, for example, any one of a feed-allowable height position, a touch position, a work end position, and a jump prevention height. The position set on the motion curve is not limited to the feed-allowable height position, the touch position, the work end position, and the jump prevention height.

The target position set by position setting unit 70A is stored in memory 44 of controller 40. Position setting unit 70A may be a part of control panel 6 shown in FIG. 2 or may be provided separately from control panel 6.

Mode selection switch 70B is a switch for selecting an operation mode and configured to select at least a “step operation mode.” Mode selection switch 70B may be configured to select both of the “step operation mode” and the “inching mode.” When the step operation mode is selected by using mode selection switch 70B, a step operation mode signal is output from mode selection switch 70B to controller 40. Controller 40 accepts an operation signal from two-hand push button panel 80 while a step operation mode signal is being input from mode selection switch 70B.

When the inching mode is selected by using mode selection switch 70B, an inching mode signal is output from mode selection switch 70B to controller 40. Controller 40 accepts an operation signal from two-hand push button panel 80 while the inching mode signal is being input from mode selection switch 70B.

Rotation direction selection switch 70C is a switch for selecting a rotation direction of main shaft 110 (FIG. 3). Rotation direction selection switch 70C includes a forward rotation button and a reverse rotation button. Main shaft 110 makes forward rotation in response to pressing of the forward rotation button, and main shaft 110 makes reverse rotation in response to pressing of the reverse rotation button. Thus, main shaft 110 can be rotated in the reverse direction by pressing of the reverse rotation button after main shaft 110 is rotated forward to a prescribed angle.

Position detector 126 is configured to detect a vertical position in upward and downward movement of slide 20. The vertical position of the slide detected by position detector 126 is input to controller 40. Position information input to controller 40 is, for example, stored in memory 44 of controller 40 or used for calculation and determination by CPU 42.

Controller 40 outputs a target value to servo amplifier 66 based on a signal and information input from two-hand push button panel 80, position setting unit 70A, mode selection switch 70B, rotation direction selection switch 70C, and position detector 126. Servo amplifier 66 gives a speed instruction to servo motor 121 based on the target value. Main shaft 110 is driven as servo motor 121 is driven, and accordingly, slide 20 moves upward and downward and press working is performed.

<Target Position of Slide 20 in Inching Mode or Step Operation Mode>

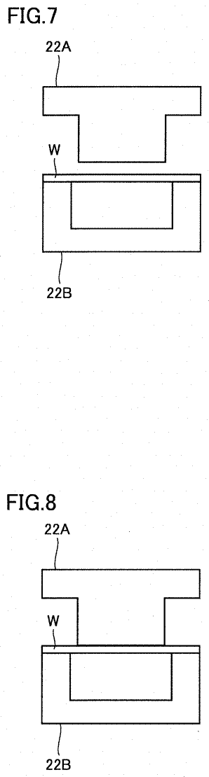

A feed-allowable height, a touch position, a work end position, and a jump prevention height exemplified as the target position of slide 20 in the inching mode or the step operation mode will now be described with reference to FIGS. 7 to 12.

The feed-allowable height refers to a lower limit of a position of slide 20 where upper die 22A does not interfere with transported workpiece W. FIG. 7 is a schematic diagram showing arrangement of the die and workpiece W when slide 20 is located at the feed-allowable height. When slide 20 is distant from bolster 5 by a distance greater than the feed-allowable height, workpiece W can be transported without interfering with upper die 22A.

The touch position refers to a position of slide 20 at the time when upper die 22A comes in contact with workpiece W. FIG. 8 is a schematic diagram showing arrangement of the die and workpiece W when slide 20 is located at the touch position. When slide 20 lowered toward bolster 5 reaches the touch position, upper die 22A comes in contact with workpiece W placed on lower die 22B.

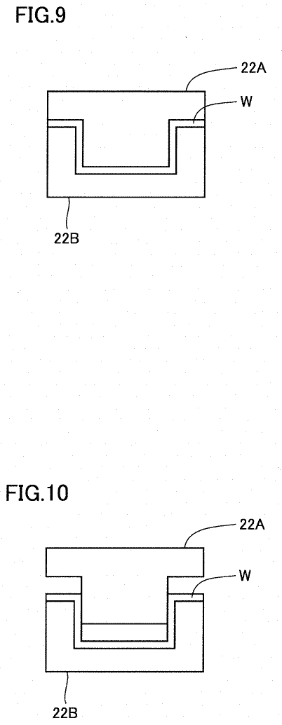

The work end position refers to a position of slide 20 at the time point of end of press working of workpiece W. FIG. 9 is a schematic diagram showing arrangement of the die and workpiece W when slide 20 is located at the work end position. When slide 20 lowered toward bolster 5 reaches the work end position, press working of workpiece W ends.

The jump prevention height is set to prevent wobble of workpiece W at the time when upper die 22A is raised after end of press working of workpiece W. FIG. 10 is a schematic diagram showing arrangement of the die and the workpiece when slide 20 is located at the jump prevention height. In order to suppress wobble of workpiece W, a speed of slide 20 is set to be low from the work end position to the jump prevention height.

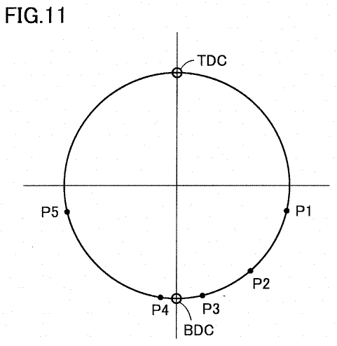

FIG. 11 is a diagram illustrating an angle of rotation of main shaft 110 corresponding to each position representing a slide position parameter. FIG. 11 shows angles of rotation of main shaft 110 corresponding to a top dead center TDC and a bottom dead center BDC, a feed-allowable height P1, a touch position P2, a work end position P3, a jump prevention height P4, and a feed-allowable height P5 of slide 20.

The operation mode of slide 20 is set, for example, to a pendular motion in which the slide is reciprocatively driven across bottom dead center BDC with feed-allowable heights P1 and P5 being defined as upper limit positions. Slide 20 starts lowering from feed-allowable height P1, sequentially passes touch position P2 and work end position P3, reaches bottom dead center BDC, moves upward from bottom dead center BDC, passes jump prevention height P4, moves to feed-allowable height P5, and stops.

As shown in FIG. 11, work end position P3 is set as a position higher than bottom dead center BDC. Lowered slide 20 passes work end position P3 before reaching bottom dead center BDC.

Jump prevention height P4 is set as a position higher than bottom dead center BDC. Slide 20 starts moving upward after it passes bottom dead center BDC, and passes jump prevention height P4. In order to prevent wobble of workpiece W between upper die 22A and lower die 22B at the time when upper die 22A is raised after end of press working of workpiece W, a speed of slide 20 while it is moved from work end position P3 to jump prevention height P4 is set to be low.

A different position of jump prevention height P4 can be set for each condition of a material property, a thickness, and a method of working of workpiece W. Set jump prevention height P4 is saved in memory 44 (FIG. 5). When jump prevention height P4 corresponding to workpiece W to be press worked has not been saved in memory 44 at the time of change in material property, thickness, or method of working of workpiece W, jump prevention height P4 is set by making trials a plurality of times before starting working.

<Press Motion (Slide Motion) and Feeder Motion>

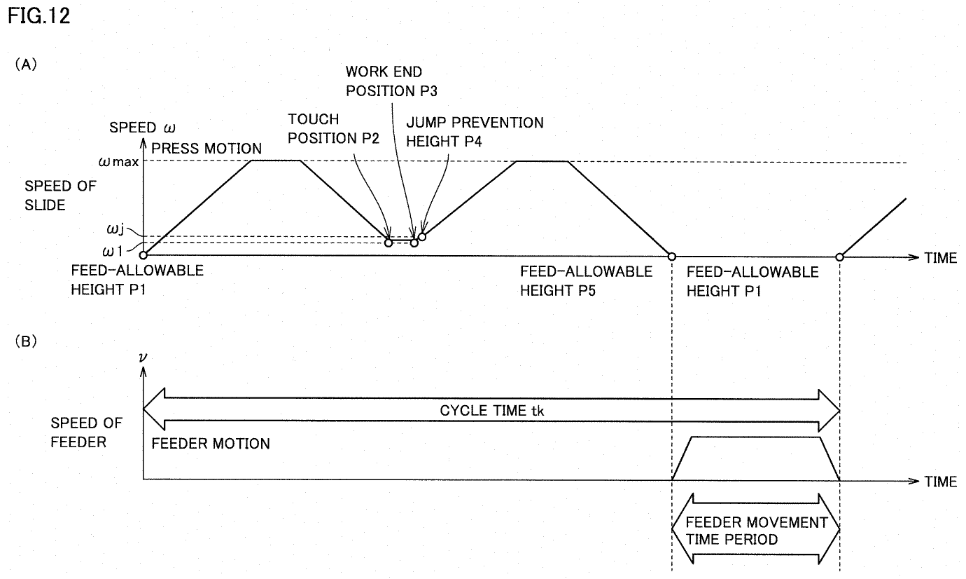

An exemplary motion curve in press working in which the feed-allowable height, the touch position, the work end position, and the jump prevention height are set and an exemplary motion curve of a feeder will now be described with reference to FIG. 12. The motion curve in press working herein is identical in meaning to a curve in the slide motion.

FIG. 12 is a diagram showing a press motion (A) and a feeder motion (B) generated by the press system based on the embodiment. The abscissa in the graph in FIG. 12 (A) represents time and the ordinate represents an angular speed co of main shaft 110. In FIG. 12 (A), feed-allowable height P1, touch position P2, work end position P3, jump prevention height P4, and feed-allowable height P5 are plotted.

An angular speed max in FIG. 12 (A) represents a value set as a maximum value of an angular speed of main shaft 110. An angular speed ω1 represents an angular speed of main shaft 110 at touch position P2 and work end position P3. An angular speed ωj represents an angular speed of main shaft 110 at jump prevention height P4.

As shown in FIG. 12 (A), feed-allowable height P1 refers to a position where slide 20 remains stopped, and hence angular speed ω of main shaft 110 at feed-allowable height P1 is zero. Slide 20 starts lowering from feed-allowable height P1 toward bottom dead center BDC, and the angular speed of main shaft 110 is increased at a prescribed acceleration until maximum angular speed ωmax is reached. After the angular speed of main shaft 110 reaches maximum speed max, maximum angular speed max is maintained for a prescribed time period. Thereafter, the angular speed of main shaft 110 is lowered at a prescribed acceleration to angular speed ω1 at touch position P2.

Thereafter, the angular speed of main shaft 110 is maintained at the same angular speed ω1 until slide 20 reaches work end position P3. Slide 20 is thus lowered at the same speed from touch position P2 to work end position P3.

When slide 20 reaches work end position P3, main shaft 110 (and slide 20) starts acceleration. While slide 20 is moving between work end position P3 and jump prevention height P4, the angular speed of main shaft 110 is increased at a relatively low acceleration from angular speed ω1 until angular speed ωj for preventing jump of workpiece W.

When slide 20 reaches jump prevention height P4, the angular speed of main shaft 110 is increased at a relatively high acceleration until maximum angular speed ωmax is reached. An acceleration from angular speed ωj to angular speed ωmax is higher than an acceleration from angular speed ω1 to angular speed ωj.

After the angular speed of main shaft 110 reaches maximum speed ωmax, maximum speed ωmax is maintained for a prescribed time period. Thereafter, the angular speed of main shaft 110 is lowered at a prescribed acceleration to a zero angular speed at feed-allowable height P5.

Main shaft 110 stops rotation at the time point when slide 20 reaches feed-allowable height P5. Slide 20 thus stops at a position at feed-allowable height P5. The press motion is generated as set forth above.

The abscissa in the graph in FIG. 12 (B) represents time and the ordinate represents a speed of transportation v of workpiece W. As shown in FIG. 12 (B), the transportation speed is increased up to the set feed rate at a prescribed acceleration from a state that workpiece W remains stopped (speed of transportation v=0). After reaching the feed rate, transportation of workpiece W at the set feed rate is continued to a position where the speed can be lowered by deceleration at a prescribed acceleration to speed of transportation v=0 at the time point of transportation of workpiece W by a set transportation length.

Workpiece W is decelerated from the set feed rate at a prescribed acceleration and stopped at the time point of transportation of workpiece W by the set transportation length. The feeder motion is generated as set forth above.

<Method of Controlling Press System>

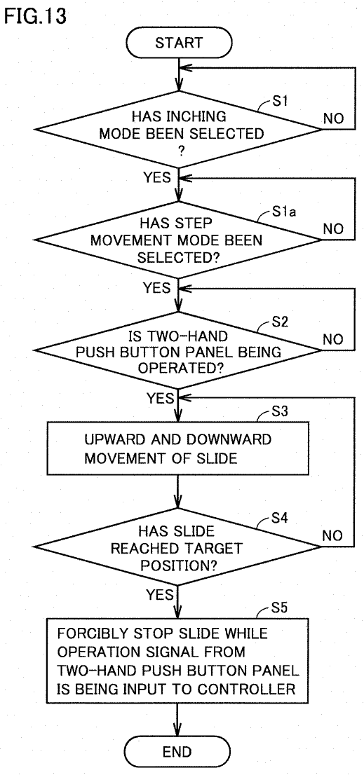

A method of controlling the press system will now be described with reference to FIG. 13.

FIG. 13 is a flowchart showing a method of controlling a press system based on the embodiment. As shown in FIG. 13, in the method of controlling a press system in the present embodiment, initially, controller 40 (CPU 42) (FIG. 6) determines whether or not the inching mode has been selected (step S1: FIG. 13). At this time, when the inching mode has been selected by using mode selection switch 70B shown in FIG. 6, an inching mode selection signal is input to controller 40. Therefore, by sensing whether or not the inching mode selection signal is being input to controller 40, whether or not the inching mode has been selected can be determined.

When it is determined that the inching mode has been selected, controller 40 (CPU 42) (FIG. 6) determines whether or not the step operation mode has been selected (step S1a: FIG. 13). When the step operation mode has been selected at this time, a step operation mode selection signal is input to controller 40. Therefore, by sensing whether or not the step operation mode selection signal is being input to controller 40, whether or not the step operation mode has been selected can be determined.

The step operation mode refers to a mode in which slide 20 moves upward and downward in accordance with a slide motion set in advance only while two-hand push button panel 80 is outputting an operation signal to controller 40, however, when slide 20 reaches a target position, slide 20 is forcibly stopped even though the operation signal from the two-hand push button panel 80 is being input to controller 40. More specifically, the step operation mode refers to a mode in which slide 20 is moved in accordance with a slide motion (a motion set speed) only while an operator keeps pressing operation buttons 80a and 80b on two-hand push button panel 80 with both of left and right hands, however, when slide 20 reaches the target position, slide 20 is forcibly (automatically) stopped even though the operator keeps pressing operation buttons 80a and 80b.

When it is determined that the step operation mode has been selected, controller 40 (CPU 42) determines whether or not the operator is operating two-hand push button panel 80 (FIG. 6) (step S2: FIG. 13). When the operator is pressing operation buttons 80a and 80b on two-hand push button panel 80 with both of left and right hands, that operation signal is input to controller 40. Therefore, by sensing whether or not the operation signal is being input to controller 40, whether or not two-hand push button panel 80 is being operated can be determined.

As set forth above, as two-hand push button panel 80 is operated with the step operation mode having been selected, slide 20 moves upward and downward at a motion set speed in a prescribed motion (step S3: FIG. 13). In the step operation mode, while the operator keeps pressing operation buttons 80a and 80b by a two-hand operation, slide 20 continues moving. Specifically, controller 40 keeps outputting a command to servo amplifier 66 to have slide 20 move upward and downward in the prescribed motion while the operator keeps pressing operation buttons 80a and 80b by the two-hand operation.

While slide 20 continues moving, whether or not slide 20 has reached the target position is determined (step S4: FIG. 13). Position detector 126 (FIG. 6) can sense a position of slide 20. The position of slide 20 sensed by position detector 126 is input to controller 40. A target position (for example, feed-allowable height P1, P5, touch position P2, work end position P3, and jump prevention height P4) is stored in memory 44 (FIG. 5) of controller 40. Therefore, controller 40 (CPU 42) (FIG. 5) can determine whether or not a position of slide 20 detected by position detector 126 is the target position stored in memory 44.

When it is determined that slide 20 has reached the target position, movement of slide 20 is forcibly stopped by controller 40 (CPU 42) even while the operation signal from two-hand push button panel 80 is being input to controller 40 (step S5: FIG. 13). Specifically, controller 40 (CPU 42) outputs a signal to stop servo motor 121 to servo amplifier 66 or stops output of the command for the upward and downward movement of slide 20 to servo amplifier 66.

When controller 40 (CPU 42) determines that slide 20 has not reached the target position, the upward and downward movement of slide 20 in the prescribed motion is continued. Alternatively, when the operator stops the operation to press operation buttons 80a and 80b, controller 40 (CPU 42) stops outputting the command for upward and downward movement of slide 20 to servo amplifier 66 so that upward and downward movement of slide 20 is stopped.

Though the control method allows switching between the normal inching mode and the step operation mode, it may be a control method with which the normal inching mode cannot be selected but only the step operation mode can be selected.

A function and effect of the present embodiment will now be described.

According to the present embodiment, when controller 40 (CPU 42) determines that slide 20 has reached a target position in the step operation mode as shown in FIG. 13, slide 20 is forcibly stopped even while the operator is operating two-hand push button panel 80. Therefore, an angle does not have to finely be adjusted by using a manual pulser for accurately stopping the slide at the target position. Therefore, as in the inching mode where slide 20 is moved in a prescribed slide motion only while two-hand push button panel 80 is outputting an operation signal, even an unskilled person with experience can accurately stop slide 20 at a prescribed position in a short period of time. Positional relation (for example, a state of contact) between a die and workpiece W can be checked at an accurate position.

According to the present embodiment, the target position at which slide 20 is forcibly stopped is a set position set on the curve of the slide motion shown in FIG. 12. Accurate positional relation between a die and workpiece W at any position set on the motion curve can thus be checked.

According to the present embodiment, the position set on the motion curve where slide 20 is forcibly stopped is any of feed-allowable height P1, P5 (FIG. 8), touch position P2 (FIG. 9), work end position P3 (FIG. 10), and jump prevention height P4 (FIG. 11) that are shown in FIG. 12. Accurate positional relation between a die and workpiece W at any set position at feed-allowable height P1, P5, touch position P2, work end position P3, and jump prevention height P4 can thus be checked.

The press apparatus is not limited to those of the construction described in the embodiment, and the press apparatus may be constructed such that a plunger and a plunger holder are interposed between the connecting rod and the slide. An eccentric mechanism may have a crankshaft structure or a drum structure.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

2 main body frame; 4 bed; 5 bolster; 6 control panel; 10 press apparatus; 20 slide; 22A upper die; 22B lower die; 33A spherical hole; 37 screw shaft; 37A spherical portion; 37B thread portion; 38 connecting rod main body; 38A female thread portion; 39 connecting rod; 40 controller; 44 memory; 46 communication circuit; 60, 66 servo amplifier; 61 display; 62, 121 servo motor; 63 transportation roller; 64, 65 encoder; 70 remote controller; 70A position setting unit; 70B mode selection switch; 70C rotation direction selection switch; 72, 74 button; 76 enter button; 80 two-hand push button panel; 80a, 80b operation button; 100 uncoiler; 110 main shaft; 110A eccentric portion; 111 side frame; 112, 113, 114, 117, 118 bearing portion; 115 main gear; 116 power transmission shaft; 116A transmission gear; 119, 123 pulley; 120 conveyor; 121A output shaft; 122, 125 bracket; 124 belt; 126 position detector; 127 rod; 128 position sensor; 129 auxiliary frame; 131, 132 bolt; 133 slide position adjustment mechanism; 134 worm wheel; 135 worm gear; 136 input gear; 137 output gear; 138 induction motor; 200 leveler feeder; BDC bottom dead center; P1, P5 feed-allowable height; P2 touch position; P3 work end position; P4 jump prevention height; TDC top dead center; W workpiece

1. A press system comprising:
a slide included in a press apparatus, the slide moving upward and downward;
a storage configured to store a target position in upward and downward movement of the slide;
an operation portion configured to output an operation signal for having the slide move upward and downward; and
a controller configured to control the slide to move upward and downward in accordance with a slide motion set in advance only while the operation portion is outputting the operation signal and to stop when the slide reaches the target position by having the slide move upward and downward while the operation signal from the operation portion is being input.

2. The press system according to claim 1, further comprising a mode selection switch with which a step operation mode can be selected, wherein
with the step operation mode having being selected, the controller is configured to control the slide to move upward and downward in accordance with the slide motion set in advance only while the operation portion is outputting the operation signal and to come to a forced stop when the slide reaches the target position by having the slide move upward and downward while the operation signal from the operation portion is being input.

3. The press system according to claim 1, wherein
the target position is a set position set on a curve of the slide motion.

4. The press system according to claim 3, wherein
the set position is any one of a feed-allowable height position, a touch position, a work end position, and a jump prevention height.

5. A method of controlling a press system comprising:
determining whether a step operation mode has been selected;
determining whether an operation signal is being output from an operation portion;
performing upward and downward movement of a slide in accordance with a slide motion set in advance while the operation signal from the operation portion is being input to a controller;
determining whether the slide has reached a target position by upward and downward movement; and
when it is determined that the slide has reached the target position, with the step operation mode having been selected, forcibly stopping the slide while the operation signal from the operation portion is being input to the controller.
